(19) United States
(12) Patent Application Publication
(10) Pub. No.: US 2015/0078861 A1
(43) Pub. Date: Mar. 19, 2015

(54) Removable Vehicular Registration Plate Fastener

(71) Applicant: Spencer James Heinz, Wheaton, IL (US)

(72) Inventor: Spencer James Heinz, Wheaton, IL (US)

(21) Appl. No.: 14/490,657

(22) Filed: Sep. 18, 2014

Related U.S. Application Data
(60) Provisional application No. 61/879,294, filed on Sep. 18, 2013.

(51) Int. Cl. F16B 5/00; F16B 43/00; F16B 33/00

(52) U.S. Cl. CPC F16B 5/00; F16B 33/00; F16B 43/00; G09F 2007/1895
USPC 411/368

(57) ABSTRACT

A removable vehicular registration plate fastener utilizes hitches that are attached to the front grill of a vehicle and hitch receivers that are attached to the vehicle's registration plate to temporarily secure the registration plate to the vehicle. The hitches are attached to the grill by a flange and a washer, which the grille is compressed between. The registration plate is secured between the receiver body and a plate attachment cap. A standoff with a ferromagnetic hitch cap is connected to the flange and is received by a hitch receiver. A magnet within the receiver body forms a magnetic bond with the hitch cap, securing the hitch within the hitch receiver. Two pairs of hitches and hitch receivers may be used for when the vehicle is not in motion, or four pairs may be used for a more secure attachment for when the vehicle is to be driven.

The current application claims a priority to the U.S. Provisional Patent application Ser. No. 61/879,294 filed on Sep. 18, 2013.

### FIELD OF THE INVENTION

The present invention relates generally to registration plates for automotive vehicles. More specifically, the present invention is a mounting system for temporarily, yet securely, attaching a front registration plate to a vehicle.

### BACKGROUND OF THE INVENTION

Conventional methods of mounting a vehicle registration plate often result in damage and loss of value of the vehicle. It is often necessary to drill holes for mounting brackets and fasteners utilized to hold a vehicle registration plate in place. The holes are drilled into the vehicle bumper or the body of the vehicle itself in order to accommodate the fasteners. This is unacceptable to vehicle owners who wish to maintain the condition and value of their vehicles and who may find drilled holes aesthetically unpleasing. The problem is exacerbated if a vehicle owner frequently removes and reattaches a front vehicle registration plate. This is common when a vehicle owner prefers to keep the front of a vehicle bare, within the legal requirements of the local municipality. However, because laws often vary based on the jurisdictions of local, provincial, and/or national governing powers, a vehicle owner may be required to reattach a front vehicle registration plate when required by law. This can result in further damage to the vehicle. Additionally, mounting a vehicle registration plate to a bracket using fasteners such as screws is time-consuming and inefficient as additional tools are required. Furthermore, it is often difficult to maintain consistent alignment, positioning, and orientation of a vehicle registration plate when constantly removing and reattaching the plate. The present invention seeks to address the aforementioned issues and provide a straightforward and consistent means of temporarily, but securely, attaching a front registration plate to a vehicle.

The present invention is a mounting system for a front vehicle registration plate that allows temporary, but secure, attachment of a registration plate to a vehicle. The present invention provides a straightforward means for a user to repeatedly remove and reattach the front vehicle registration plate without the use of additional tools or damage to the vehicle. In its preferred embodiment, the present invention comprises a hitch assembly and a hitch receiver assembly and is primarily designed for use in conjunction with various style grills found on many vehicles, including but not limited to honeycomb style grill openings, square openings, or circular openings. When mounting a vehicle registration plate to the honeycomb grill of a vehicle, two hitches and two hitch receivers are used. The two hitches are secured to the front grill of a vehicle and serve as two metallic mounting points. This configuration is intended for displaying the registration plate when the vehicle is not in motion. Four hitches and four hitch receivers are used for driving situations in order to provide enhanced stability.

The objective of the present invention is to facilitate efficient removal and reattachment of a front vehicle registration plate without the use of additional tools and without resulting in damage to the vehicle. The present invention maintains consistency in terms of alignment, positioning, and orientation of the vehicle registration plate, particularly when the user frequently removes and reattaches the plate.

### BRIEF DESCRIPTION OF THE DRAWINGS

FIG. 1 is a side view of one hitch and one hitch receiver separated from each other.

FIG. 2 is a perspective view of one hitch and one hitch receiver separated from each other.

FIG. 3 is a perspective exploded view of one hitch and one hitch receiver separated from each other.

FIG. 4 is a perspective exploded view of a second embodiment.

FIG. 5 is a side sectional view of the second embodiment.

FIG. 6 is a perspective view of the configuration used to secure a registration plate when the vehicle is not in motion.

FIG. 7 is a rear perspective view of the configuration used to secure a registration plate when the vehicle is in motion.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a mounting system for temporarily, but securely, attaching a registration plate to the front of a vehicle. In its preferred embodiment, the present invention comprises a plurality of hitches 1 and a plurality of hitch receivers 2. The hitches 1 are affixed to the front of the vehicle, preferably traversing through a front grill of the vehicle. The hitch receivers 2 are affixed to the registration plate. The hitches 1 may be removably attached within a hitch receiving cavity 22 of one of the hitch receivers 2 by a fastener 23 of the hitch receiver. The hitch receivers 2 are easily and quickly able to be engaged and disengaged from the hitches 1 so that affixing the registration plate to the vehicle is also easy and quick. The preferred embodiment of the present invention is primarily intended for use in conjunction with honeycomb-style vehicle grills such as the grill of the Tesla Model S. Alternate embodiments of the present invention may be used with many other vehicle makes, such as, but not limited to, BMW, Mercedes, Audi, and other vehicles. Additionally, the present invention may be used with other grill styles, such as, but not limited to, grills with square openings, round openings, rhomboidal openings, or other opening shapes.

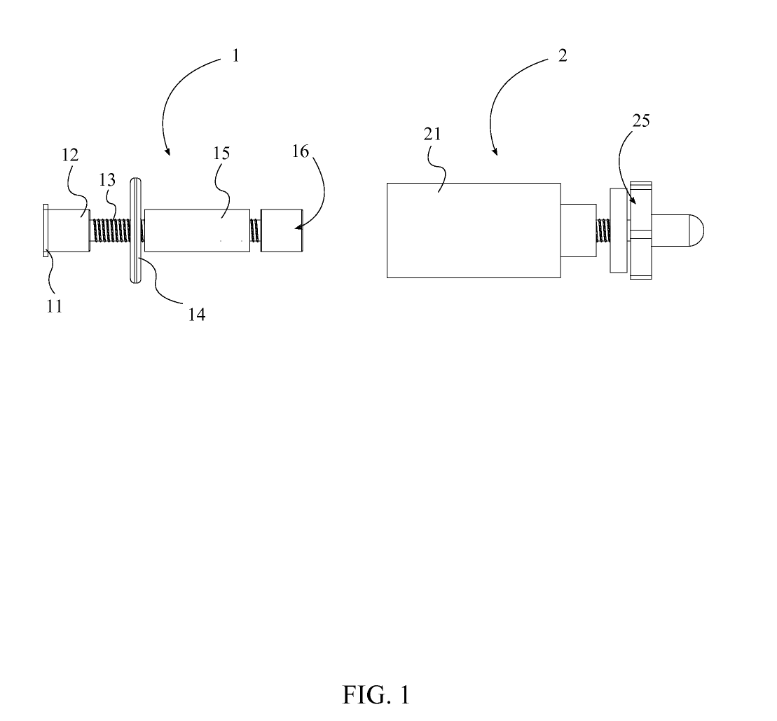

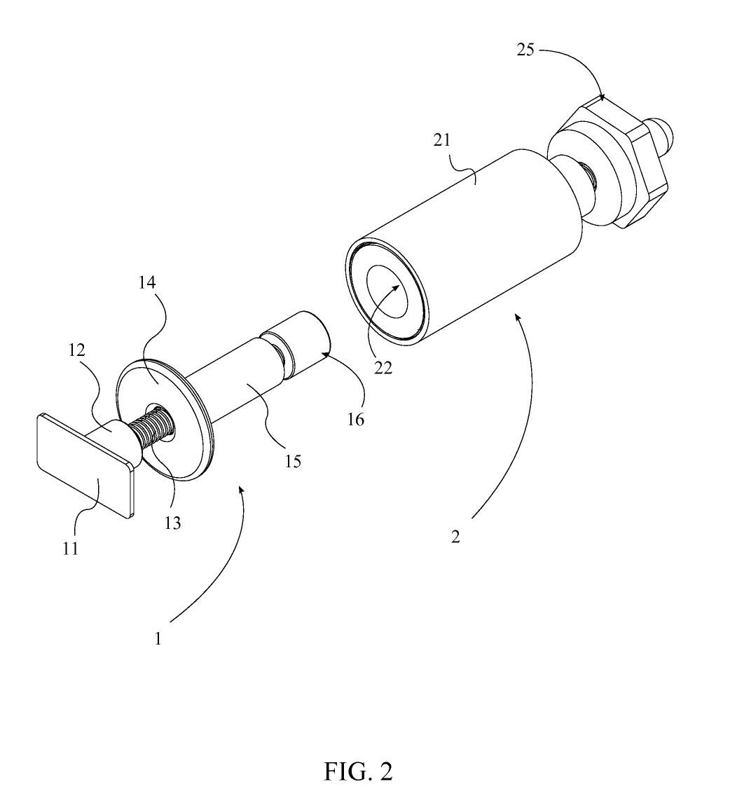

Referring to FIGS. 1-2, each of the plurality of hitches 1 comprises a flange 11, a flange screw 13, a hitch washer 14 and a standoff 15. In the preferred embodiment of the present invention, the flange 11 is rectangular in shape and a flange connecting protrusion 12 is connected perpendicularly to the flange 11. The flange connecting protrusion 12 is preferably cylindrical but this is not absolutely necessary and may be another shape such as being rectangular in shape. The flange screw 13 is axially connected to the flange 11 protrusion opposite the flange 11. The flange screw 13 may be threadedly engaged within an internal thread within the flange 11 protrusion, but in the preferred embodiment of the present invention, the flange 11, flange connecting protrusion 12, and the flange screw 13 are machined as a singular piece of precision machined stainless steel.

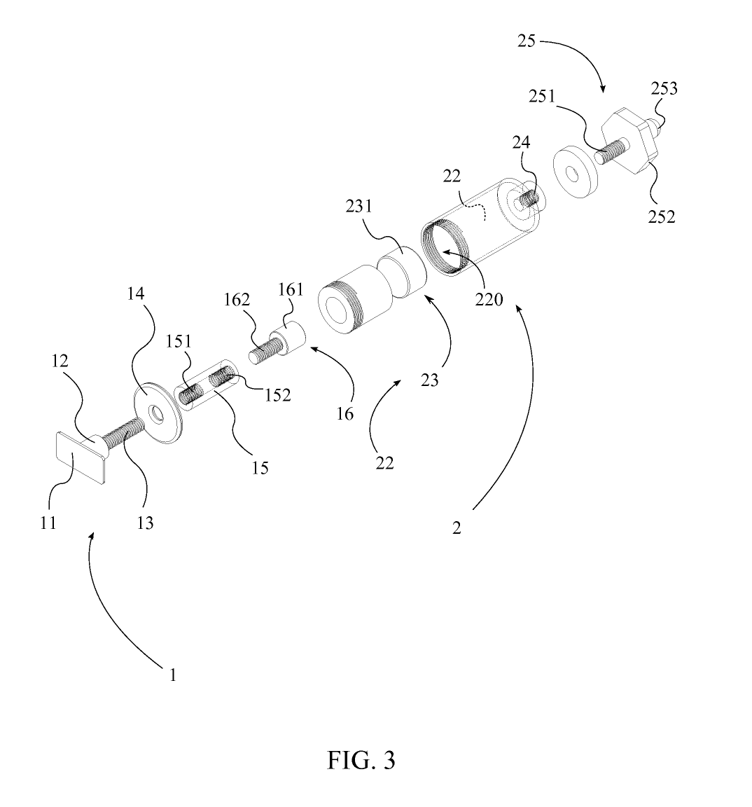

The standoff 15 is an elongated piece of hardware typically used to connect screw threaded fasteners to each other. In the preferred embodiment, the standoff 15 is a female-female standoff 15 comprising a first internal screw thread 151 and a second internal screw thread 152 which are positioned axially with each other and opposite each other within the standoff 15, as can be seen in FIG. 3. The flange screw 13 is threadedly engaged into the first internal screw thread 151 of the standoff 15. Thus the standoff 15 is oriented perpendicular to the flange 11. The hitch washer 14 is positioned concentrically around the flange screw 13, between the flange connecting protrusion 12 and the standoff 15. Therefore, the flange screw 13 is connected to the standoff 15 through the hitch washer 14. When the hitch is attached to the vehicle's grill, the material of the grill is gripped between the flange 11 and the hitch washer 14. An additional rubber washer should also be positioned concentrically around the flange screw 13, between the hitch washer 14 and the flange connecting protrusion 12. The rubber washer protects the vehicle's grill from damage by providing a soft cushion between the grill and the metal washer, in addition to providing a form fitting friction fit which prevents displacement of the hitch. Alternatively, the hitch washer 14 may be encapsulated in a rubber coating, providing the same functionality as utilizing two washers, or the hitch washer 14 may be made of a material that has sufficient strength, non-abrasiveness and friction to provide the same functionality.

In an alternate embodiment, the flange 11 is a commonly known piece of hardware known as a T-nut. In this embodiment, the flange screw 13 is another commonly known piece of hardware known as a set screw, which is a cylindrical extrusion with external screw threads. A first end of the set screw is threadedly engaged within, or screwed into, an internally threaded hole located centrally on the T-nut, and is secured within said internally threaded hole of the T-nut with thread locker gel. A second end of the set screw opposite the first end is threadedly engaged into the first internal screw thread 151 of the standoff 15.

The standoff 15 is able to press against the hitch washer 14. In order to affix one of the hitches 1 to the grill, the flange 11 is inserted through an opening of the grill by aligning the long sides of the flange 11 to corresponding openings of the grill. It is assumed that the honeycombed openings of the grill are also generally rectangular, and that the long dimension of the flange 11 is longer than the short dimension of the honeycombed openings. After the flange 11 is inserted through the correct grill opening, the hitch is rotated at an angle such that the flange 11 is blocked from coming out of the grill by the grill opening border, since the long dimension of the flange 11 is longer than the short dimension of the grill openings. In grills with substantially rectangular openings, the flange 11 should be secured at 90 degrees. An angle less than 90 degrees may be sufficient, but not ideal. The standoff 15 is then rotated relative to the set screw in the direction that moves the standoff 15 closer to the flange 11, thereby pressing on the washer with the standoff 15, and compressing the grill between the washer and the flange 11. This holds the hitch in place on the grill.

In a first preferred embodiment of the present invention, each of the hitches 1 further comprises a hitch cap 16 which is connected to the standoff 15 opposite the flange 11. More particularly, the hitch cap 16 comprises a hitch cap head 161 and a hitch cap screw 162, which are both cylindrical and connected axially adjacent with each other. The hitch cap 16 comprises a ferromagnetic material. More specifically, the hitch cap head 161 is made of ferromagnetic material in order to facilitate the hitches 1 being removably attached within the hitch receivers 2. The hitch cap screw 162 of the hitch cap 16 is removably and threadedly engaged within the second internal screw thread 152 of the standoff 15.

In the first embodiment of the present invention, each of the plurality of hitch receivers 2 comprises a receiver body 21, a hitch receiving cavity 22, a fastener 23, and a receiver internal screw thread 24. The hitch receiving cavity 22 axially traverses partially into the receiver body 21. The internal diameter of the hitch receiving cavity 22 should be slightly larger than the external diameter of the hitch cap 16 and the standoff 15. In the first embodiment, the fastener 23 is a magnet 231 which attracts the ferromagnetic material of the hitch cap 16. The magnet 231 should have a sufficient enough magnetic field to securely hold the hitches 1 and hitch assemblies together while not being too strong for a user to remove. In the preferred embodiment, the magnetic bond between the magnet 231 and the ferromagnetic material requires five pounds of force to separate. However, magnets of varying strengths may be used. The magnet 231 is positioned within the hitch receiving cavity 22 opposite an opening of the hitch receiving cavity 22. The receiver internal screw thread 24 is positioned opposite the hitch receiving cavity 22 on the receiver body 21. The receiver internal screw thread 24 and the hitch receiving cavity 22 are concentrically positioned with each other.

In the first embodiment, each of the hitch receivers 2 further comprises a plate attachment cap 25 comprising a plate attachment screw 251. The plate attachment screw 251 is removably and threadedly engaged within the receiver internal screw thread 24, wherein a registration plate may be held between the plate attachment cap 25 and the receiver body 21 when the plate attachment cap 25 is engaged within the receiver internal screw thread 24.

The plate attachment cap 25 comprises a hexagonal flange 252 which is oriented perpendicular to the plate attachment screw 251, and is connected axially adjacent to the plate attachment screw 251. The hexagonal flange 252 provides a means for a user to tighten the plate attachment cap 25 relative to the receiver body 21. The plate attachment cap 25 additionally comprises an end cap protrusion 253 connected axially adjacent to the hexagonal flange 252 opposite the plate attachment screw 251. The end cap protrusion serves as a storage area for a protective cap when the registration plate is mounted on the vehicle utilizing the present invention.

In order to secure one of the hitch receivers 2 to one of the hitches 1, the hitch receiving cavity 22 is placed over the hitch cap 16 and standoff 15 until the magnet 231 engages the hitch cap 16, so that a magnetic bond is formed between the magnet 231 and the standoff 15. The magnetic bond secures the vehicle registration plate to the front of the vehicle grill and allows a user to quickly remove and reattach the plate as needed without the need for additional tools or causing damage to the vehicle. The vehicle registration plate may be removed by pulling the plate away from the vehicle grill until the magnetic bond between the hitch receivers 2 and the hitches 1 is broken.

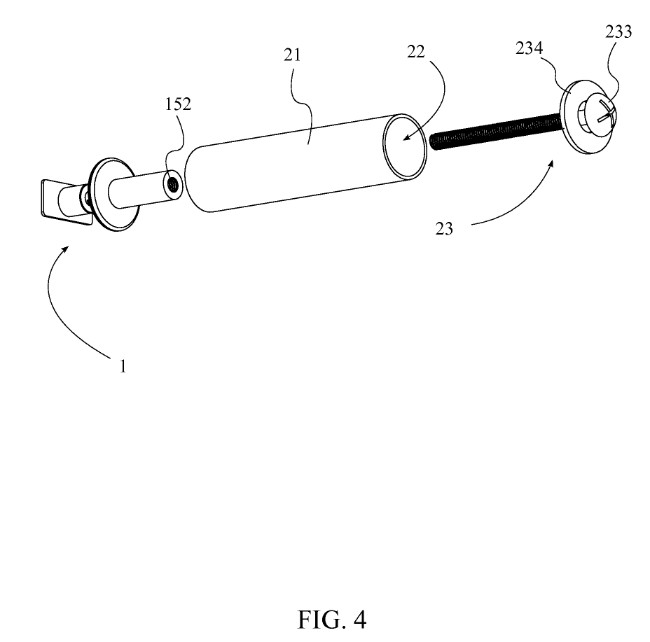

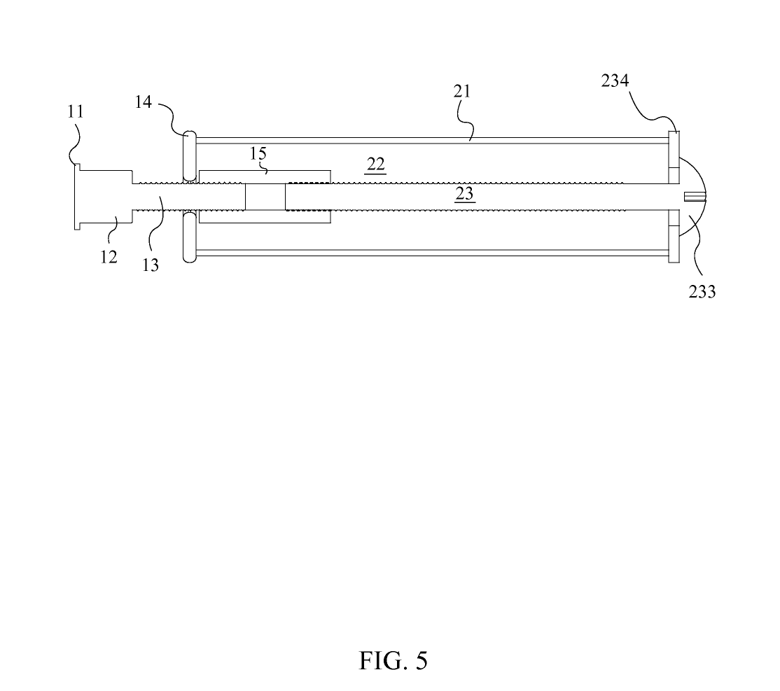

In a second preferred embodiment shown in FIGS. 4-5, the receiver body 21 is simply a hollow cylinder; therefore, the hitch receiving cavity 22 of each of the hitch receivers 2 axially traverses fully through the receiver body 21. In this second embodiment, the fastener 23 of each of the hitch receivers 2 is an elongated screw 232. The elongated screw 232 comprises a screw head 233. A plate attachment washer 234 is concentrically positioned around the elongated screw 232, between the screw head 233 and the receiver body 21 in order to prevent the screw head 233 from moving into the hitch receiving category upon tightening the elongated screw 232.

To attach one of the hitch receivers 2 to one of the hitches 1, the receiver body 21 is concentrically positioned around the standoff 15. The elongated screw 232 is inserted through a fastener 23 hole on the registration plate and subsequently into the hitch receiving cavity 22. The elongated screw 232 is then threadedly engaged within the second internal screw thread 152 of the standoff 15, instead of the hitch cap 16 as comprised in the first embodiment. The registration plate is therefore affixed between the screw cap and the receiver body 21.

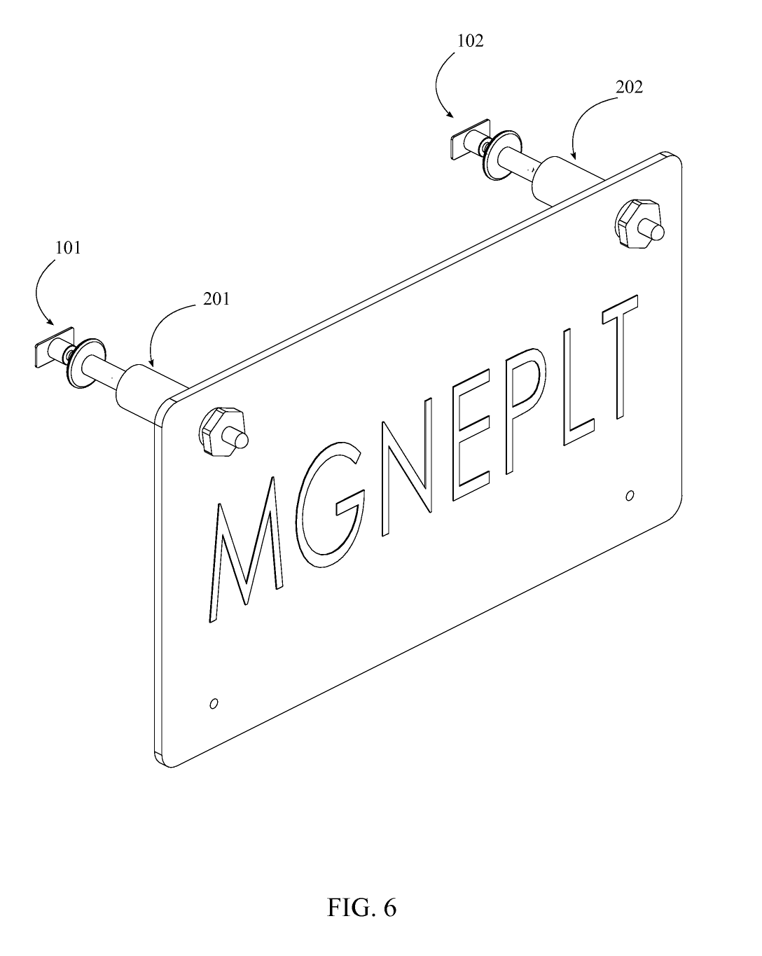

In one embodiment of the present invention shown in FIG. 6, the plurality of hitches 1 comprises a first hitch 101 and a second hitch 102, and the plurality of hitch receivers 2 comprises a first hitch receiver 201 and a second hitch receiver 202. The first hitch 101 is removably attached within the first hitch receiver 201; likewise, the second hitch 102 is removably attached within the second hitch receiver 202. The first hitch 101 and the second hitch 102 are installed onto the front end of a vehicle in a horizontal arrangement. The first hitch receiver 201 and the second hitch receiver 202 are installed onto the registration plate on the upper fastener holes of the registration plate. This embodiment is primarily intended for use when the vehicle is parked.

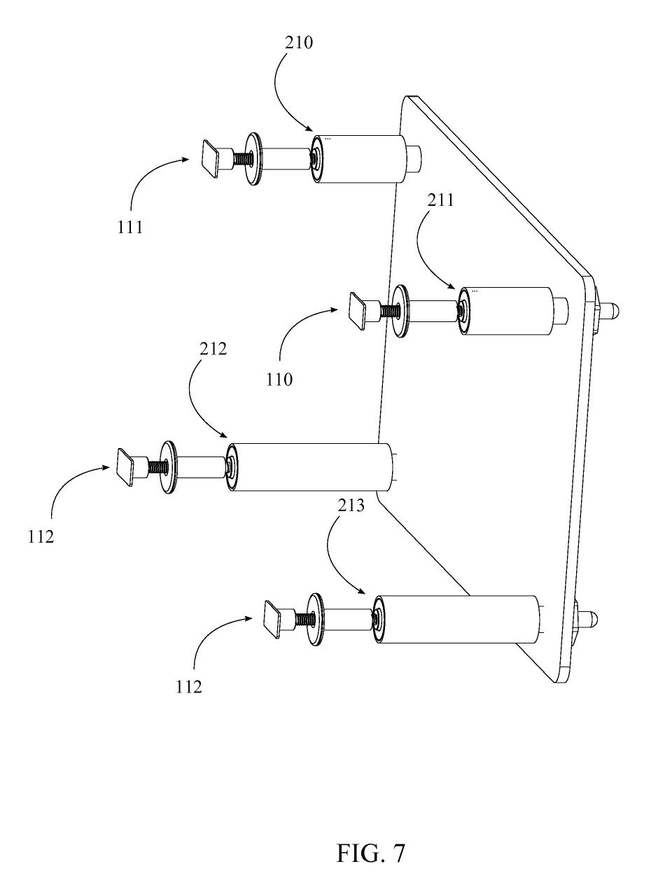

In another embodiment of the present invention shown in FIG. 7, the plurality of hitches 1 comprises a first upper hitch 110, a second upper hitch 111, a first lower hitch 112 and a second lower hitch 113, and the plurality of hitch receivers 2 comprises a first upper hitch receiver 210, a second upper hitch receiver 211, a first lower hitch receiver 212 and a second lower hitch receiver 213. Each of the plurality of hitches 1 is affixed to the front end of the vehicle in a rectangular arrangement that matches the arrangement of the four fastener holes of the registration plate. Each of the plurality of hitch receivers 2 are installed into the four fastener holes of the registration plate. The first upper hitch 110 is removably attached within the first upper hitch receiver 210 and the second upper hitch 111 is removably attached within the second upper hitch receiver 211. The first lower hitch 112 is removably attached within the first lower hitch receiver 212 and the second lower hitch 113 is removably attached within the second lower hitch receiver 213. This provides a more secure attachment, particularly when the vehicle is in motion.

Preferably, the receiver body 21 of the first lower hitch receiver 212 and the second lower hitch receiver 213 are each longer than the receiver body 21 of the first upper hitch receiver 210 and the second upper hitch receiver 211. Grills of many vehicles are shaped so that the lower portion of the grill to which the first lower hitch 112 and the second lower hitch 113 are attached is positioned slightly to the rear of the upper portion of the grill, where the first upper hitch 110 and the second upper hitch 111 are attached. Various grill shapes may have varying projection depths, and so the components of the present invention, preferably the receiver body 21 of the hitch receivers 2, may vary in length to accommodate said variations. The result is that if the lower hitches 1 and the upper hitches 1 were the same length, the registration plate would be angled offset from vertical. This is undesirable for aesthetic and practical reasons; therefore, the lower hitches 1 should generally be longer than the upper hitches 1. It is contemplated that some vehicle grills may have a projection depth that requires the upper hitches 1 to be longer than the lower hitches 1. This may be accomplished by any useful means. The receiver bodies of the lower hitch receivers 2 may simply be manufactured to be longer than the receiver bodies of the upper hitch receivers 2. However in the preferred embodiment of the present invention, the lower hitch receivers 2 comprise a body extension portion, which is simply axially attached to the receiver body 21, preferably by a screw threaded connection. Additionally, it is contemplated that some embodiments of the present invention may comprise means to adjust the length of various components in order to provide a universally applicable device. For example, the receiver body 21 may be able to extend through a twisting or telescoping mechanism.

The present invention may be used in conjunction with a rubberized plate protector. The rubberized plate protector envelops the rear surface of the vehicle registration plate and the edges of the plate as well. In this configuration, a magnet is affixed to the rubber backing of the plate protector or to the vehicle registration plate. This allows a user to attach a magnetic ribbon with a reminder message to remove the vehicle registration plate if desired. The rubberized plate protector allows a user to store removable end caps for the hitches 1. This allows the user to cover the exposed ends of the hitches 1 when the vehicle registration plate is not mounted to the vehicle grill. In addition to being aesthetically more pleasing, covering the exposed ends of the hitches 1 allows a user to preserve the exterior surface finish of the hitches 1, particularly in the wintertime when sand, salt, and other roadside elements may potentially damage the finish.

In a further alternative embodiment of the present invention, the mounting system for the present invention may be utilized in conjunction with a camera mounting bracket. The camera mounting bracket comprises two mounting holes for attachment to two additional hitch receivers 2. The camera mounting bracket comprises a mounting point corresponding to the mounting point of a camera. Similarly, the mounting system may be utilized in conjunction with an electronic toll-collection pass and system. The user may mount an electronic toll-collection pass to a vehicle in various configurations utilizing the mounting system. The pass alone may be mounted directly and permanently to the female standoffs 15 of the mounting system. Alternatively, the pass may be affixed to the hitch receivers 2 and attached magnetically to the hitches 1. Finally, the pass may be secured to the vehicle registration plate itself and affixed magnetically to the hitch receivers 2.

Although the invention has been explained in relation to its preferred embodiment, it is to be understood that many other possible modifications and variations can be made without departing from the spirit and scope of the invention as hereinafter claimed.

What is claimed is:

1. A removable vehicular registration plate fastener comprises:
a plurality of hitches;
a plurality of hitch receivers;
each of the plurality of hitches comprises a flange, a flange screw, a hitch washer and a standoff;
each of the plurality of hitch receivers comprises a receiver body, a hitch receiving cavity, and a fastener;
the hitch washer being positioned between the flange and the standoff;
the flange being connected to the standoff through the hitch washer;
the hitch receiving cavity axially traversing into the receiver body; and
each of the plurality of hitches being removably attached within the hitch receiving cavity of one of the hitch receivers by the fastener of the hitch receiver.

2. The removable vehicular registration plate fastener as claimed in claim 1 comprises:
the flange being rectangular in shape.

3. The removable vehicular registration plate fastener as claimed in claim 1 comprises:
a flange connecting protrusion being connected perpendicular to the flange; and
the flange screw being axially connected to the flange protrusion opposite the flange.

4. The removable vehicular registration plate fastener as claimed in claim 3 comprises:
the flange being axially connected to the standoff by the flange screw.

5. The removable vehicular registration plate fastener as claimed in claim 1 comprises:
the standoff being oriented perpendicular to the flange.

6. The removable vehicular registration plate fastener as claimed in claim 1 comprises:
each of the hitches further comprises a hitch cap; and
the hitch cap being connected to the standoff opposite the flange.

7. The removable vehicular registration plate fastener as claimed in claim 6 comprises:
the hitch cap comprises a hitch cap head and a hitch cap screw; and
the hitch cap head and the hitch cap screw being connected axially adjacent with each other.

8. The removable vehicular registration plate fastener as claimed in claim 6 comprises:
the hitch cap comprises a ferromagnetic material.

9. The removable vehicular registration plate fastener as claimed in claim 6 comprises:
a hitch cap head of the hitch cap being made of a ferromagnetic material.

10. The removable vehicular registration plate fastener as claimed in claim 1 comprises:
the standoff comprises a first internal screw thread and a second internal screw thread;
the first internal screw thread and the second internal screw thread being positioned opposite each other within the standoff;
the flange screw being threadedly engaged within the first internal screw thread, wherein the flange screw connects the flange to the standoff; and
a hitch cap screw of the hitch cap being removably and threadedly engaged within the second internal screw thread.

11. The removable vehicular registration plate fastener as claimed in claim 1 comprises:
each of the hitch receivers further comprises a receiver internal screw thread;
the fastener of each of the hitch receivers being a magnet;
the receiver internal screw thread being positioned opposite the hitch receiving cavity on the receiver body; and
the magnet being positioned within the hitch receiving cavity opposite an opening of the hitch receiving cavity.

12. The removable vehicular registration plate fastener as claimed in claim 11 comprises:
the receiver internal screw thread and the hitch receiving cavity being concentrically positioned with each other.

13. The removable vehicular registration plate fastener as claimed in claim 11 comprises:
each of the hitch receivers further comprises a plate attachment cap;
the plate attachment cap comprises a plate attachment screw; and
the plate attachment screw being removably and threadedly engaged within the receiver internal screw thread, wherein a license plate may be held between the plate attachment cap and the receiver body when the plate attachment cap is engaged with the receiver internal screw thread.

14. The removable vehicular registration plate fastener as claimed in claim 13 comprises:
the plate attachment cap comprises a hexagonal flange;
the hexagonal flange being oriented perpendicular to the plate attachment screw; and
the hexagonal flange being connected axially adjacent to the plate attachment screw.

15. The removable vehicular registration plate fastener as claimed in claim 14 comprises:
the plate attachment cap further comprises an end cap protrusion; and
the end cap protrusion being connected axially adjacent to the hexagonal flange opposite the plate attachment screw.

16. The removable vehicular registration plate fastener as claimed in claim 1 comprises:
the hitch receiving cavity of each of the hitch receivers axially traversing fully through the receiver body, wherein the receiver body is a hollow cylinder; and
the fastener of each of the hitch receivers being an elongated screw.

17. The removable vehicular registration plate fastener as claimed in claim 16 comprises:
the receiver body being concentrically positioned around the standoff;
the elongated screw being positioned within the hitch receiving cavity; and
the elongated screw being removably and threadedly engaged within a second internal screw thread of the standoff.

18. The removable vehicular registration plate fastener as claimed in claim 16 comprises:
the elongated screw comprises a screw head;
a plate attachment washer being concentrically positioned around the elongated screw; and
the plate attachment washer being positioned between the screw head and the receiver body.

19. The removable vehicular registration plate fastener as claimed in claim 1 comprises:
the plurality of hitches comprises a first hitch and a second hitch;
the plurality of hitch receivers comprises a first hitch receiver and a second hitch receiver;
the first hitch being removably attached within the first hitch receiver; and
the second hitch being removably attached within the second hitch receiver.

20. The removable vehicular registration plate fastener as claimed in claim 1 comprises:
the plurality of hitches comprises a first upper hitch, a second upper hitch, a first lower hitch and a second lower hitch;
the plurality of hitch receivers comprises a first upper hitch receiver, a second upper hitch receiver, a first lower hitch receiver and a second lower hitch receiver;
the first upper hitch being removably attached within the first upper hitch receiver;
the second upper hitch being removably attached within the second upper hitch receiver;
the first lower hitch being removably attached within the second upper hitch receiver; and
the second lower hitch being removably attached within the second lower hitch receiver.
